(19) United States
(12) Patent Application Publication
(10) Pub. No.: US 2005/0058419 A1
(43) Pub. Date: Mar. 17, 2005

(54) Integrated optical device

(76) Inventors: John Massa, Ipswich (GB); Adrian Taylor, Worlingworth (GB)

Correspondence Address: PERMAN & GREEN, 425 POST ROAD, FAIRFIELD, CT, 06824, US

(21) Appl. No.: 10/879,803

(22) Filed: Jun. 29, 2004

(30) Foreign Application Priority Data
Sep. 11, 2003 (GB) 0321263.6

(51) Int. Cl. G02B 6/10

(52) U.S. Cl. 385/129

(57) ABSTRACT

The present invention provides an integrated optical device comprising two optical devices. One of the optical devices that comprise the integrated optical device may have undergone quantum well intermixing to provide a shift in the absorption edge of that device. The absorption edge may be shifted to a longer wavelength. In one embodiment the integrated optical device comprises a laser and a electro absorption modulator and in a further embodiment the integrated optical device comprises a laser and a detector.

The present invention relates to integrated optical devices and in particular to the integration of a semiconductor laser with a further optical device, such as an electro absorption modulator (EAM) or an optical detector.

Optical transmission systems have seen dramatic increases in data transmission rates, with 10 Gb/s systems in use in many SDH networks, with 40 Gb/s systems under development. One technique that has been used to obtain such data transmission rates is external modulation of optical sources. Conventionally, optical sources such as laser diodes have been directly modulated by supplying the modulating signal to an electrode connected to the active region of the laser such that the output of the laser varies with the modulating signal. The main drawback with this technique is that the data transmission rates are limited by the photonic transitions that govern the population inversion and radiative decay. In comparison, external modulation relies upon an optical device that can be switched between an attenuating state and a substantially non-attenuating state such that data can be modulated onto the constant output of an optical source. One device that is commonly used to provide external modulation is an electro absorption modulator (EAM), the structure and operation of an example of an EAM is described in EP-B-0 143 000.

A conventional method of fabricating an EAM-DFB (distributed feedback laser) utilises quantum well (QW) intermixing to introduce a wavelength shift on the absorption edge of the modulator section of the EAM-DFB. There are problems associated with this technique, namely that the intermixing of the QW and barrier materials reduces the definition of the QW edges, leading to a reduction in the exciton binding energy, which in turn leads to a broadening and a reduction in the amplitude of the excitonic absorption feature. As the modulation of an EAM-DFB is dependent upon the manipulation of the absorption edge by the application of an electric field, the intermixing will decrease the modulation contrast and increase the voltage required to provide a desired level of modulation.

According to a first aspect of the invention there is provided an integrated optical device comprising a first optical device and a second optical device, the first optical device and the second optical device comprising quantum well material, the integrated optical device being characterised in that the first optical device comprises intermixed quantum well material, the absorption edge of the intermixed quantum well material having a greater wavelength that the quantum well material.

In a first embodiment of the present invention the first optical device comprises a laser and the second optical device comprises an electro absorption modulator (EAM). The laser and the EAM may be in optical communication such that the light emitted by the laser is modulated by the EAM. Since the wavelength of the absorption edge of the laser section is shifted, rather than that of the modulator section, as in conventional designs, the modulation contrast of the EAM section will not be degraded.

In a second embodiment of the present invention the first optical device comprises a detector and the second optical device comprises a laser. The detector and the laser may be in optical alignment. The intermixed quantum well material in the detector may increase the absorption of the detector.

The invention will now be described, by way of example only, with reference to the following Figures in which:

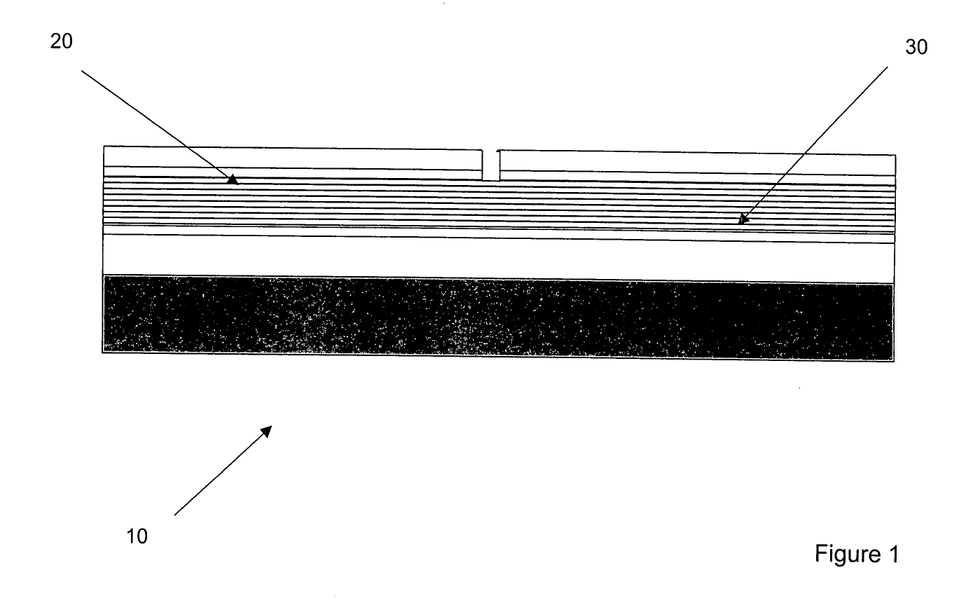

FIG. 1 shows a schematic depiction of a side view of an integrated optical device according to the present invention;

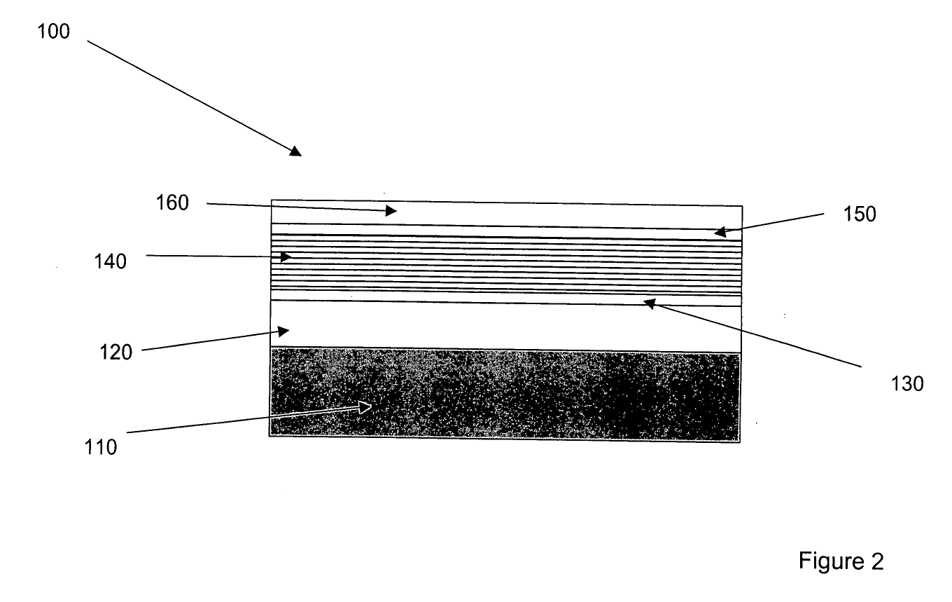

FIG. 2 shows a schematic depiction of the cross-section of an integrated optical device according to the present invention; and

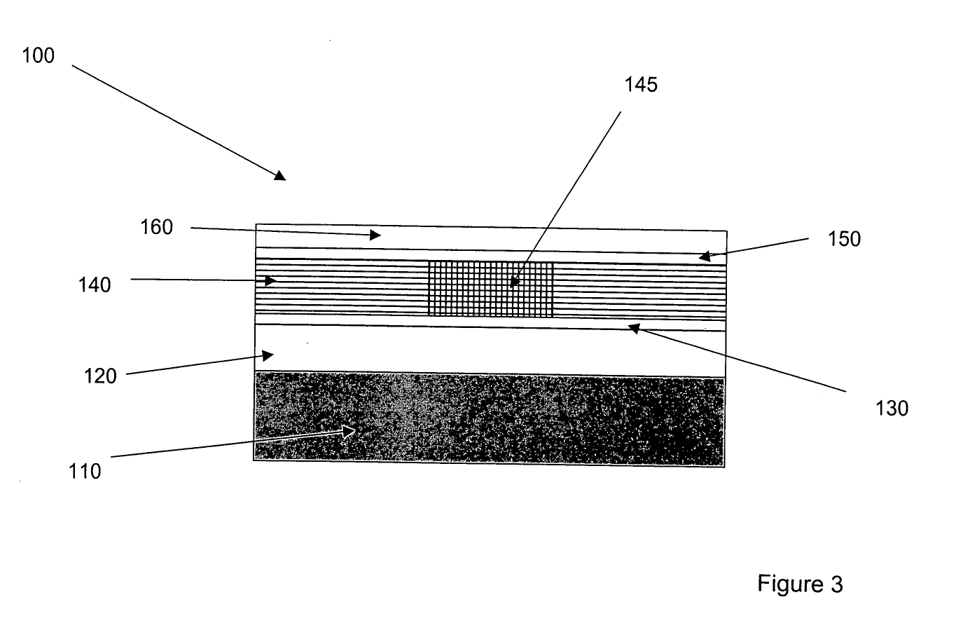

FIG. 3 shows a schematic depiction of a second cross-section of the integrated optical device of FIG. 2.

FIG. 1 shows a schematic depiction of a side view of an integrated optical device 10 according to the present invention. The integrated optical device comprises a first optical device 20 and a second optical device 30.

FIG. 2 shows a schematic depiction of the cross-section of an integrated optical device 100 according to the present invention, the integrated optical device being an electro absorption laser modulator The laser modulator is formed by depositing an n-type InP cladding layer 120 on a substrate 110, the substrate 110 being sulphur doped InP with a carrier density of approximately 4×10⁻¹⁸ cm⁻³. The cladding layer has a thickness of approximately 1.5 μm and a carrier density of approximately 3×10⁻¹⁸ cm⁻³. A lower confinement layer 130 comprising undoped tensile strained InGaAsP is formed on the cladding layer 120 and the undoped InGaAsP MQW layer 140 is formed on the lower confinement layer 130. The structure is completed by forming an upper confinement layer 150 on the MQW layer 140 and a protection layer 160 on the upper confinement layer 150. The upper confinement layer comprises undoped tensile strained InGaAsP and the protection layer comprises InP and is approximately 20 μm thick.

Once these layers are formed the laser modulator is patterned to separate the laser section from the modulator section and a QW intermixing process is used to move the absorption edge of the laser section material to a higher wavelength. FIG. 3 shows a schematic depiction of the cross-section of the laser section of the laser modulator described above with reference to FIG. 2. MQW layer 140 now further comprises intermixed MQW region 145.

The patterning will then be removed and the wafer returned to the growth reactor so that a cladding layer of p-type InP with a thickness of approximately 0.4 μm and a carrier density of approximately 1.3×10⁻¹⁸ cm⁻³ can be deposited. The wafer will then undergo conventional mesa etch and overgrowth processes (with the blocking layer being one of pnpn, pnip or semi-insulating InP). The laser section is isolated from the modulator section by etching down to the active layer to provide a three contact device. The fabrication of the device is completed using techniques well known in the manufacture of buried heterostructure devices.

In a further embodiment of the invention an integrated optical device according to the present invention may comprise a semiconductor laser integrated with an optical detector. In optical transceivers, it is conventional for a laser to be aligned with an optical fibre so as to launch light into the fibre. A receiver will be positioned behind, and aligned with, the laser in order to receive light emitted from the rear facet of the laser.

An integrated laser-detector may be fabricated using a wafer as described above with reference to FIG. 2. Once the wafer has been formed it will be patterned in order to separate the laser section from the detector section. The material in the detector section is then processed to intermix the QW material and shift the absorption edge to higher wavelengths. This shift in the absorption edge causes the responsivity of the detector to be increased. The detector responsivity may be further increased by increasing the length of the detector section.

The patterning will then be removed and the wafer returned to the growth reactor so that a cladding layer of p-type InP with a thickness of approximately 0.4 μm and a carrier density of approximately 1.3×10⁻¹⁸ cm⁻³ can be deposited. The wafer will then undergo conventional mesa etch and overgrowth processes (with the blocking layer being one of pnpn, pnip or semi-insulating InP). The laser section is isolated from the detector section by etching down to the active layer to provide a three contact device. The fabrication of the device is completed using techniques well known in the manufacture of buried heterostructure devices.

An advantage of integrating a laser with a detector is that the laser and the detector can be aligned such that only one device needs to be aligned with an optical fibre during the packaging of a opto-electronic device. This will significantly reduce the amount of time required to package such a device and lead to more cost effective manufacturing of such devices.

The selected regions of the integrated optical device may be intermixed using one of a number of conventional techniques. For example, silica may be deposited on the area to be intermixed before the wafer is annealed for a short period of time, for example, 800° C. for 60 seconds. It is understood that the intermixing mechanism is dependent upon the deposition process causing sputter damage and that during the annealing phase impurities diffuse into the MQW region and cause the intermixing. The wavelength shift caused by the QW intermixing is dependent upon the temperature and duration of the annealing phase. For an integrated laser-modulator a wavelength shift of about 50 nm is desirable but for an integrated laser-detector a greater wavelength shift is preferred in order to increase the absorption within the detector.

Where not specifically defined above n-type dopants may be selected from sulphur, silicon, selenium, copper and tin and p-type dopants may be selected from zinc, cadmium and beryllium. It will be readily apparent to the person skilled in the art that the devices described above may be fabricated using different choices of materials and dopants and that different choices of layer thickness and doping concentration may be made without effecting the functionality of the devices.

1. An integrated optical device comprising:
a first optical device and a second optical device,
the first optical device and the second optical device including quantum well material,
the first optical device further including intermixed quantum well material, the absorption edge of the intermixed quantum well material having a greater wavelength than the quantum well material.

2. An integrated optical device according to claim 1, wherein the first optical device comprises a laser and the second optical device comprises an electro absorption modulator.

3. An integrated optical device according to claim 2, wherein the laser and the EAM are in optical communication such that the light emitted by the laser is modulated by the EAM.

4. An integrated optical device according to claim 2, wherein the intermixed quantum well material in the laser improves the modulation contrast of the integrated optical device.

5. An integrated optical device according to claim 1, wherein the first optical device comprises a detector and the second optical device comprises a laser.

6. An integrated optical device according to claim 5, wherein the detector and the laser are in optical alignment.

7. An integrated optical device according to claim 5, wherein the intermixed quantum well material in the detector increases the absorption of the detector.
